(19) United States
(12) Patent Application Publication
(10) Pub. No.: US 2006/0091184 A1
(43) Pub. Date: May 4, 2006

(54) METHOD OF MITIGATING VOIDS DURING SOLDER REFLOW

(76) Inventors: Art Bayot, Baguio City (PH); Richard Valerio, Marikina City (PH)

Correspondence Address: TEXAS INSTRUMENTS INCORPORATED, P O BOX 655474, M/S 3999, DALLAS, TX, 75265, US

(21) Appl. No.: 10/975,774

(22) Filed: Oct. 28, 2004

(51) Int. Cl. B23K 1/06

(52) U.S. Cl. 228/110.1; 228/180.22

(57) ABSTRACT

A Solder bump is formed by providing solder material on a conductive site of a substrate. The solder material is reflowed to provide a solder bump on the substrate. The solder material is ultrasonically agitated during at least a part of the reflow to at least partially mitigate formation of voids in the solder bump.

### TECHNICAL FIELD

The present invention relates generally to electronic device packaging and more particularly to a method of reflowing solder on a substrate.

### BACKGROUND OF THE INVENTION

Modern electronics utilize numerous integrated circuits. These integrated circuits can often be electrically connected to each other or to other electronic components. One method of connecting integrated circuits to electronic components utilizes an area array electronic package, such as a ball-grid array (BGA) package or a flip-chip package. With BGA packages, various input and output ports of an integrated circuit are typically connected by wire bonds to contact pads of the BGA package. Solder bumps formed on the contact pads of the BGA package are used to complete the connection to another electronic component, such as a printed circuit board (PCB).

Solder bumps can be formed using methods, such as printing of solder paste through a stencil or mask, electroplating, evaporation, and mechanical transfer of preformed solder ball or spheres. While electroplating, printing of solder paste through a stencil or mask, and evaporation techniques have been typically utilized for forming solder bumps on integrated circuits, BGAs have commonly utilized printing of solder paste and mechanical transfer of preformed solder balls to form solder bumps. The solder paste and solder balls transferred to contact pads can then be thermally reflowed to form the solder bumps, which are metallurgically bonded to the contact pads.

The reflowing solder process can potentially cause the introduction of gas bubbles or gas pockets in the solder itself. These gas bubble or gas pockets can remain trapped in the solder and form defects, such as voids or cracks, once the solder hardens. Such defects are undesirable in a solder bump because they act as both electrical and thermal insulators and thereby increase both the electrical impedance and thermal impedance of the solder bump.

### SUMMARY OF THE INVENTION

The present invention relates to a method of forming a plurality of solder bumps arrayed on conductive sites of a surface of a substrate. The method includes forming solder bumps on the contact pads of the substrate by providing portions of solder material on each of the contacts pads and then reflowing the solder material to bond the solder material to the contact pads. The solder material can include preformed solder balls that are adhered to the contact pads with solder flux or solder paste. Alternatively, the solder material can comprise a solder paste. During at least part of the reflow, the solder material is ultrasonically agitated to reduce the formation of voids in the solder bumps. Ultrasonic agitation of the solder material during the reflow can at least partially mitigate gas bubbles or gas pockets that result from solder flux or solder paste being heated from becoming trapped and forming voids in the solder once the solder hardens. Solder bumps that have a reduced number of voids have an improved electrical and thermal properties compared with solder bumps that have more voids because the voids act as both electrical and thermal insulators and thereby increase both electrical and thermal impedance.

### BRIEF DESCRIPTION OF THE DRAWINGS

The foregoing and other aspects of the present invention will become apparent to those skilled in the art to which the present invention relates upon reading the following description with reference to the accompanying drawings.

FIG. 1 illustrates a schematic cross-sectional of a substrate with a plurality of contact pads to which has been attached solder balls in accordance with an aspect of the present invention.

FIG. 2 illustrates a schematic cross-sectional view of the substrate of FIG. 1 during a reflow process in accordance with an aspect of the invention.

FIG. 3 illustrates a schematic cross-sectional view of the structure of FIG. 2 after the solder balls have been reflowed to form solder bumps.

FIG. 4 illustrates a schematic cross-sectional view of a substrate with a plurality of contact pads to which has been attached portions of solder paste in accordance with another aspect of the present invention.

FIG. 5 illustrates a schematic cross-sectional view of the substrate of FIG. 2 during a reflow process in accordance with an aspect of the invention.

FIG. 6 illustrates a schematic view of the structure of a reflow system that can perform the reflow process in accordance with an aspect of the invention.

### DETAILED DESCRIPTION

The present invention comprises an improved method of forming a plurality of solder bumps arrayed on conductive sites of a surface of a substrate. The term “substrate” is used in a broad generic sense herein to include any semiconductor device including a wafer or a packaged or unpackaged bare die, as well as traditional substrates used in the formation of ball grid array (BGA) packages. The method of the present invention can be applied to the formation of solder bumps on any conductive site, whether the conductive site (e.g., a contact pad) projects from the substrate or is recessed therein. The terms “conductive site” and “contact pad” are used interchangeably herein to denote any site at which a solder bump can be formed.

The method of the present invention includes forming solder bumps on the contact pads of the substrate by providing portions of solder material on each of the contacts pads and then reflowing the solder material to bond the solder material to the contact pads. The solder material can include preformed solder balls that are adhered to the contact pads with solder flux or solder paste. Alternatively, the solder material can comprise a solder paste. During at least part of the reflow, the solder material is ultrasonically agitated to reduce the formation of voids in the solder bumps. Ultrasonic agitation of the solder material during the reflow can at least partially mitigate gas bubbles or gas pockets that result from solder flux or solder paste being heated from becoming trapped and forming voids in the solder once the solder hardens. Solder bumps that have a reduced number of voids have an improved electrical and thermal properties compared with solder bumps that have more voids because the voids act as both electrical and thermal insulators and thereby increase both electrical and thermal impedance.

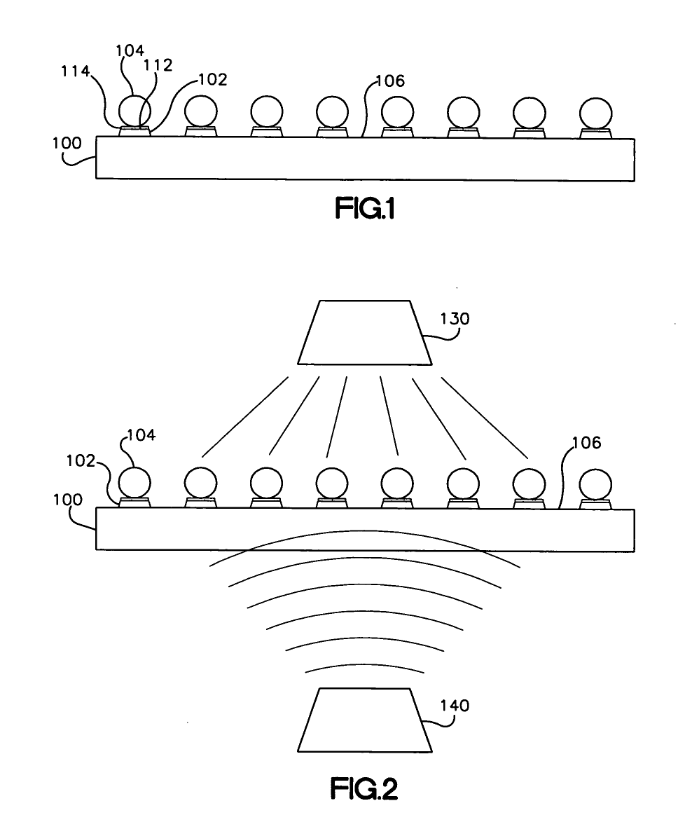

FIGS. 1-3 illustrate a method of forming a plurality of conductive solder bumps on a ball grid array package in accordance with an aspect of the invention. In the method, the plurality of solder bumps are formed from a plurality of preformed solder balls that are provided on the surface of the substrate. It will be appreciated that although the following method is illustrated for forming the solder bumps on a substrate of a ball grid array package, the method can be used to form solder bumps on a wafer or a packaged or unpackaged bare semiconductor die.

Referring to FIG. 1, a substrate 100 of a ball grid array package is provided having a plurality of exposed contact pads 102 to which preformed solder balls 104 are attached. The substrate 100 need not be restricted to a specific material. The substrate 100 can comprise a substantially planar sheet of insulative material, such as fiberglass (e.g., flame retardant fiberglass composite substrate board), polyimide tape (e.g., bismaleimide-triazine resin (BT-resin)), or ceramic. Alternatively, the substrate 100 can comprise a layer on a semiconductor die, such as silicon oxide (SiO), silicon nitride (Si₃N₄), polyimide, silicon dioxide (SiO₂), or some other insulative material formed on a die. It will be appreciated that other materials can be used to form the substrate 100.

The contact pads 102 can comprise a material that will form a metallurgical bond with the particular type of solder balls 104, which are attached. The contacts pad 102 can also be electrically connected to conductive vias (not shown) or conductive traces (not shown) that are formed either in or on the substrate 100. In one aspect of the invention, the contact pads 102 can be formed from a metal, for example copper, copper alloy, aluminum, aluminum alloy, tungsten, tungsten alloy, gold, silver, nickel, tin, platinum, iridium, or combinations of the foregoing. The contact pads 102 can be formed, for example, by depositing (e.g., CVD, electroless and electrolytic plating, and evaporation techniques) or laminating a layer metal on a surface 106 of the substrate 100. The contact pads 104 can then be defined by patterning (e.g., lithography techniques) the metal layer and etching the metal layer. It will be appreciated that other methods can be used to form the contact pads 102. Moreover, it will be appreciated that, although the contacts pads 102 are illustrated as projecting from a surface 106 of the substrate 100, the contact pads 102 can be recessed in the surface 106.

The solder balls 104 are adhered to surfaces 112 of the respective contact pads 102 using a solder flux 114. The solder balls 104 are substantially spherical and can have a diameter of about 0.3 mm to about 1.0 mm. Although the solder balls 104 are illustrated as being substantially spherical, the solder balls 104 can have various forms, such as semispherical, half-dome, and truncated cone. The materials used to form the solder balls 104 can include alloys of lead, tin, indium or silver (e.g., 90/10 SnPb, 63/37 SnPb, and 63/34.5/2/0.5 Sn/Pb/Ag/Sb solder). It will be appreciated that other materials can also be used.

The solder flux 114 maintains the solder balls 104 in position on the surfaces 112 of the contact pads 102 before and during reflow or other processing of the solder balls 104 and the substrate 100. The solder flux 114 also cleans and prepares the surfaces 112 of the contact pads 102 so that a substantially metallurgical bond can be formed between the solder balls 104 and the contact pads 102. The solder flux 114 can include any type of flux commonly used in solder ball connection in semiconductor processing. Examples of solder fluxes that can be used include rosin based fluxes (R-type), rosin mildly activated fluxes (RMA-type), rosin super activated fluxes (RSA-type) water-soluble type fluxes, and no-clean type fluxes. It will be appreciated that other flux chemistry systems can also be used and are within the scope of the invention.

The solder flux 114 can be provided directly on the contact pads 102 prior to placement of the solder balls 104 on the contact pads 102. For example, in one method, the solder flux 114 can be placed on the contact pads 102 using a stamping system (not shown). In another method, the solder flux 114 can be placed on the contact pads 102 using screen printing system (not shown). It will be appreciated that other methods can be used to place the solder flux 114 on the contact pads 102 prior to placing the solder balls 104.

Following placement of the solder flux 114 on the contact pads 102, the solder balls can be placed on the contact pads using various solder ball placement techniques. For example, in one technique, a pick-up tool (not shown) having a plurality of solder ball receiving cavities configured to match the arrangement of contact pads 102 on the substrate 100 can be used to position the solder balls 104 on the contact pads 102. It will be appreciated that other methods of placing the solder balls 104 on the contact pads can be used, such as screening the solder balls 104 through apertures of a template aligned over the contact pads 102 or aligning the solder balls 104 on an adhesive tape to correspond with the contact pads 102 and pressing the adhesive tape to the substrate 100. It will be further appreciated that the solder flux 114 can be provided on the solder balls 104 prior to placement of the solder balls 104 on the contact pads 102.

FIG. 2 illustrates the solder balls 104 undergoing a reflow process. During the reflow process the solder balls 104 are heated in an inert atmosphere by a heater 130 to at least partially melt the solder balls 104 and wet the contact pads 102. The inert atmosphere prevents oxidation and corrosion of the solder balls 104 during reflow. The inert atmosphere can comprise an inert gas, such as nitrogen gas (N₂). It will be appreciated, however, that other inert gases (e.g., Ar) as well as forming gas can also be used. By way of example, the heater 130 can include a halogen lamp that irradiates the solder balls 104 with infrared radiation to cause the solder balls 104 to at least partially melt and wet the contact pads 102. Alternatively, the heater 130 can include a convection heater that heats the solder balls 104 with a heated gas to allow the solder balls 104 to at least partially melt and wet the contact pads 102. It will also be appreciated that the both infrared and convection heating can be used heat solder balls 104 as well as other heating means.

The solder balls 104 can be heated by the heater 130 from a first temperature to a peak temperature. The first temperature is typically about room temperature (e.g., about 25° C.) and the peak temperature is a temperature substantially higher than the first temperature and above the melting point of the solder balls 104 (e.g., about 225° C.). Heating of the solder balls 104 from the first temperature to the peak temperature can be controlled so that temperature of the solder balls is increased at a substantially constant rate. The time period for this heating is dependent on the solder used and can be, for example, about 350 to about 450 seconds.

Once the temperature of the solder balls 104 has reached the peak temperature (e.g., about 225° C.) and the solder balls 104 have at least partially melted, the solder balls 104 can be maintained within about 5° C. of the peak temperature for short time period (e.g., about 10 to about 25 seconds). The total time above liquidus for the solder balls 104 is that amount of time effective to allow the solder balls 104 to reshape and wet the contact pads 102. The solder balls 104 are then cooled to room temperature at a substantially uniform rate to allow the solder balls 104 to solidify and metallurgically bond to the contact pads 102.

During at least part of the reflow process, the solder balls 104 are ultrasonically agitated by an ultrasonic generator 140 to reduce formation of voids in the reflowed solder balls 104. Ultrasonic agitation of the solder balls during reflow can facilitate evacuation of gas formed upon heating the solder flux or solder paste to the peak temperature and thereby at least partially mitigate formation of gas pockets or gas bubbles in the reflowed solder balls. At least partially mitigating the formation of gas pockets or gas bubbles in the reflowed solder balls can reduce the formation of voids in the reflowed solder balls.

The ultrasonic generator 140 can ultrasonically agitate the solder balls during reflow by applying vibrational (or acoustical) energy to the solder balls 104. The vibrational energy has frequency that can be greater than about 20 kHz (i.e., an ultrasonic frequency). In one aspect of the invention, the frequency of the ultrasonic vibration can be about 50 KHz to about 90 kHz. An ultrasonic vibration with a frequency of about 50 KHz to about 90 kHz is effective to cause gas to evacuate from the solder balls 104 during reflow and at least partially mitigate the formation of gas pockets or gas voids. This acoustical or vibrational energy can be applied though the substrate 100 to the solder balls in contrast to being applied directly to the solder balls 104 to prevent ball deformation.

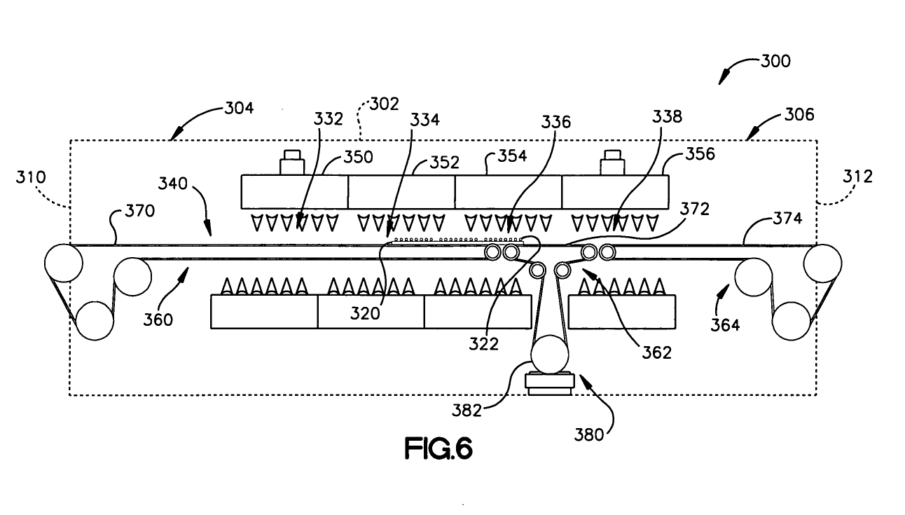

The ultrasonic generator 140 can apply an ultrasonic vibration to the substrate 100 and hence the solder balls 104 during reflow via an ultrasonic transmitting means (not shown). The ultrasonic transmitting means can comprise a gas, such as an inert gas between the ultrasonic generator 140 and the substrate 100. For example, the inert gas can comprise an ambient gas between the ultrasonic generator 140 and the substrate 100. Alternatively, the ultrasonic transmitting means can comprise a mechanical means that is in contact with the substrate 100. In one aspect, as shown in FIG. 6, the ultrasonic transmitting means can comprise a conveyor assembly on which the substrate can be disposed.

The ultrasonic generator 140 can include an ultrasonic transducer (not shown) that is capable of converting electrical energy to ultrasonic energy, which can be applied by the ultrasonic transmitting means to the solder balls. By way of example, the ultrasonic transducer can include an ultrasonic generating means, such as an oscillator with an oscillation source and a power supply. When the oscillator is driven, the ultrasonic generating means propagates an acoustical or vibrational wave with a frequency, which can be transmitted by the ultrasonic transmitting means.

The ultrasonic agitation in accordance with the present invention can be applied during the reflow process while the solder balls 104 are at least partially molten for a duration of time effective to mitigate the formation of gas bubbles or gas pockets in the reflowed solder balls 104. In one aspect of the invention, the ultrasonic agitation is applied to the solder balls 104 during the time above the liquidus of solder balls for a duration of time of about 50 seconds to about 150 seconds. It will be appreciated by one skilled in art that duration of time can be longer or shorter depending on the specific solder material used to form the solder balls 104 as well as the reflow temperature profile or parameters.

FIG. 3 illustrates the reflowed and ultrasonically agitated solder balls 104 are bonded to the contact pads 102 to form a plurality of substantially spherical shaped solder bumps 150 with top surfaces 152 to which other devices (e.g., printed circuit board) can be attached and a bottom surface 154 that is in contact with the contact pad 102. The solder bumps 150 so formed have a reduced number of voids. The reduced number of voids in the solder bumps 150 provides the solder bumps 150 with an improved electrical and thermal properties, which facilitates interconnection with, for example, a printed circuit board.

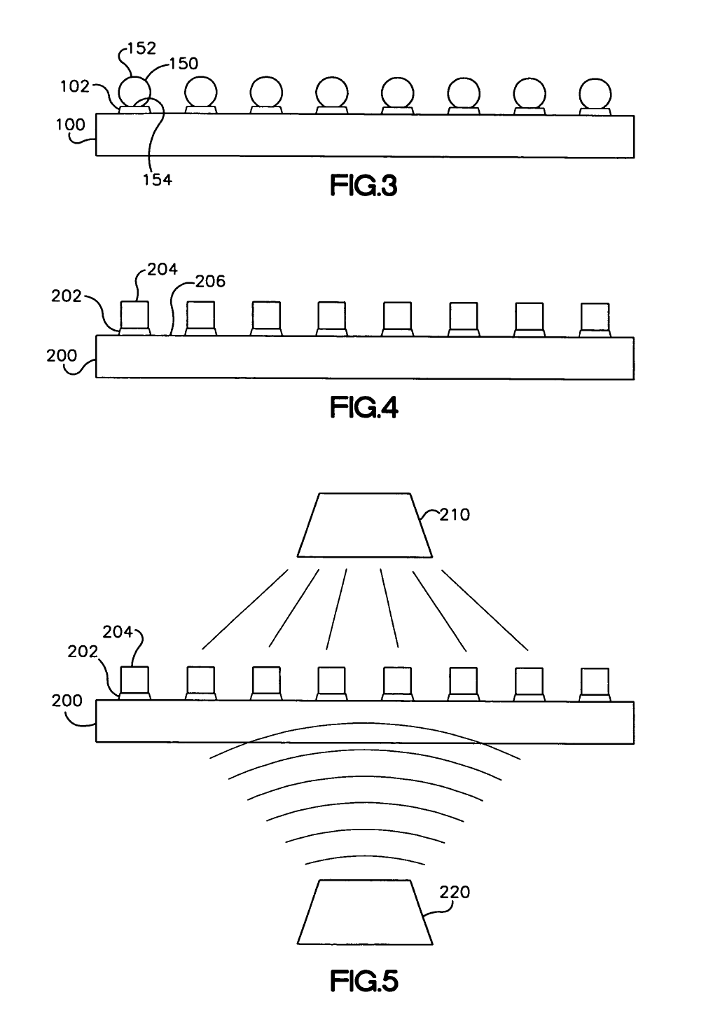

FIGS. 4-5 illustrate a method of forming a plurality of conductive solder bumps on a substrate of a ball grid array package in accordance with another aspect of the invention. In this method, the solder bumps are formed from a solder paste that is applied to conductive sites of the substrate. As with the above-described method, it will be appreciated that the following method can also be used to form solder bumps on a wafer or a packaged or unpackaged bare semiconductor die.

Referring to FIG. 4, a substrate 200 of a ball grid array package is provided having a plurality of exposed contact pads 202 to which portions of solder paste are applied. The substrate 200 can include a substantially planar sheet of insulative material, such as fiberglass, polyimide tape, or ceramic, as well as a layer on a semiconductor die, such as silicon oxide (SiO), silicon nitride (Si₃N₄), polyimide, silicon dioxide (SiO₂), or some other insulative material formed on a die. It will be appreciated that other materials can be used to form the substrate 200.

The contact pads 202 can comprise a material that will form a metallurgical bond with the solder paste. The contacts pad 202 can also be electrically connected to conductive vias (not shown) or conductive traces (not shown) that are formed either in or on the substrate 200. The contact pads 202 can be formed from a metal, such as copper, copper alloy, aluminum, aluminum alloy, tungsten, tungsten alloy, gold, silver, nickel, tin, platinum, iridium, or combinations of the foregoing. The contact pads 202 can be formed, for example, by depositing or laminating a layer metal on a surface 206 of the substrate 200. The contact pads 202 can then defined by patterning the metal layer and etching the metal layer. It will be appreciated that other methods can be used to form the contact pads 202. Moreover, it will be appreciated that, although the contacts pads 202 are illustrated as projecting from a surface 206 of the substrate 200, the contact pads 202 can be recessed in the surface 206.

The portions of solder paste 204 can provided over the contact pads 202 using solder paste dispensing methods, such as a screen printing method. In utilizing the screen printing method, the mean particle size of the solder paste 204 should be about one-third the size of the mesh size of the screen (not shown) to ease the portions of solder paste through the screen. The screen, which is typically made from stainless steel wire, can be positioned slightly above the contact pads 202 in a plane that is parallel to the substrate 200. The contact pads 202 of the substrate 200 should be located in exact registration with the with the screen image. The solder paste 204 is then drawn across and trough the screen by a squeegee so that individual portion of solder paste 204 are applied directly over each contact pad 202. It will be appreciated that other solder application methods can be used to apply solder paste over the contact pads, such as stencil methods.

The solder paste 204 can include alloys of lead, tin, indium or silver (e.g., 96.5/3.5 Sn/Ag solder alloy) and a solder flux. The solder flux can include any type of flux commonly used in solder pastes for semiconductor processing. Examples of solder fluxes that can be used include rosin based fluxes (R-type), rosin mildly activated fluxes (RMA-type), rosin super activated fluxes (RSA-type) water-soluble type fluxes, and no-clean type fluxes. It will be appreciated that other solder based chemistry systems can also be used and are within the scope of the invention.

FIG. 5 illustrates the portions of solder paste 204 undergoing a reflow process. During the reflow process the portions of solder paste 204 are heated in an inert atmosphere by a heater 210 to at least partially melt the portions of solder paste 204 and wet the contact pads 202. The inert atmosphere prevents oxidation and corrosion of the solder paste 204 during reflow. The inert atmosphere can substantially comprise nitrogen gas (N₂). It will be appreciated, however, that other inert gases can also be used. The heater 210 can include a halogen lamp that irradiates the portions of solder paste 204 with infrared radiation to cause the portions of solder paste 204 to at least partially melt and wet the contact pads 202. Alternatively, the heater 210 can include a convection heater that heats the portions of solder paste 204 with a heated gas to allow the portions of solder paste 204 to at least partially melt and wet the contact pads 202. It will be appreciated that the both infrared and convection heating can be used to heat the solder paste as well as other heating means can be used to heat the portions of solder paste.

As with the heating of the solder balls, the portions of solder paste 204 can be heated by the heater 210 from a first temperature to a peak temperature. The first temperature is typically about room temperature (e.g., about 25° C.) and the peak temperature is a temperature substantially higher than the first temperature and above the melting point of the solder alloy of the solder paste (e.g., about 225° C.). Heating the portions of solder paste 204 from the first temperature to the peak temperature can be controlled so that temperature of the portions of solder paste is increased at a substantially constant rate. Time period for this heating is dependent on the solder used and can be, for example, about 350 to about 450 seconds.

Once the temperature of the solder paste 204 has reached the peak temperature (e.g., about 225° C.) and the solder paste 204 has at least partially melted, the solder paste 204 can be maintained within about 5° C. of the peak temperature for short time period (e.g., about 10 to about 25 seconds). The total time above liquidus for the solder paste 204 is that amount of time effective to allow the portions of solder paste 204 to reshape in a substantially spherical configurations and wet the contact pads. The portions of reflowed solder paste 204 are then cooled to room temperature at a substantially uniform rate to allow the portions of reflowed solder paste 204 o solidify and metallurgically bond to the contact pads 202.

During at least part of the reflow process, the portions of solder paste 204 are ultrasonically agitated by an ultrasonic generator 220 to reduce formation of voids in the reflowed portions of solder paste 204. Ultrasonic agitation of the portions of solder paste 204 during reflow can facilitate evacuation of gas formed upon heating the solder paste 204 to the peak temperature and thereby at least partially mitigate formation of gas pockets or gas bubbles in the reflowed solder paste 204.

The ultrasonic generator 220 can ultrasonically agitate the portions of solder paste during reflow by applying vibrational (or acoustical) energy to the solder paste 204. The vibrational energy has frequency that can be greater than about 20 kHz (i.e., an ultrasonic frequency). In one aspect of the invention, the frequency of the ultrasonic vibration can be about 50 kHz to about 90 kHz. An ultrasonic vibration with a frequency of about 50 kHz to about 90 kHz is effective to cause gas to evacuate from paste during reflow and at least partially mitigate the formation of gas pockets or gas voids. This acoustical or vibrational energy can be applied though the substrate 200 to the solder paste 204 in contrast to being applied directly to the solder paste 204 to prevent deformation.

The ultrasonic generator 220 can apply an ultrasonic vibration to the substrate 200 and hence the portions of solder paste 204 during reflow through an ultrasonic transmitting means (not shown). The ultrasonic transmitting means can comprise a gas, such as an inert gas between the ultrasonic generator 220 and the substrate 200. By way of example, the inert gas can comprise ambient gas between the ultrasonic transducer and the substrate. Alternatively, the ultrasonic transmitting means can comprise mechanical means (not show) that is in contact with the substrate 200. In one aspect, as shown in FIG. 6, the ultrasonic transmitting means can comprise a conveyor assembly on which the substrate can be disposed.

The ultrasonic generator 220 can include an ultrasonic transducer (not shown) that is capable of converting electrical energy to ultrasonic energy, which can be applied by the ultrasonic transmitting means to the portions of solder paste 204. By way of example, the ultrasonic transducer can include an ultrasonic generating means, such as an oscillator with an oscillation source and a power supply. When the oscillator is driven, the ultrasonic generating means propagates an acoustical or vibrational wave with a ultrasonic frequency that can be transmitted by the ultrasonic transmitting means to the portions of solder paste 204.

The ultrasonic agitation can be applied during the reflow process while the portions of solder paste 204 are at least partially molten for a duration of time effective to mitigate the formation of gas bubbles or gas pockets in the reflowed solder paste 204. In one aspect of the invention, the ultrasonic agitation is applied to the solder paste during the time above the liquidus of solder paste 204 for a duration of time of about 50 seconds to about 150 seconds. It will be appreciated by one skilled in the art that the duration of time can be longer or shorter depending on the specific solder material used to form the solder paste 204 as well as the reflow temperature profile or parameters.

Following reflow and ultrasonic agitation, the portions of solder paste 204 are bonded to the contact pads 202 to form a plurality of substantially spherical shaped solder bumps, such as shown in FIG. 3, to which other devices (e.g., printed circuit board) can be attached. The solder bumps so formed have a reduced number of voids. The reduced number of voids in the solder bumps provides the solder bumps with improved electrical and thermal properties, which facilitates interconnection with a printed circuit board.

FIG. 6 illustrates an example of a system 300 for reflowing solder material on a substrate in accordance with an aspect of the invention. The system includes a reflow chamber 302 that contains a substantially inert ambient. The ambient can comprise a substantially inert gas (e.g., N₂) or a forming gas (e.g. 95% N₂/H₂). It will be appreciated that other inert gases can also be used.

The reflow chamber 302 has an input end 304 and an output end 306. The input end 304 and output end 306 respectively include ambient loading zones 310 and 312 that can be opened to an external atmosphere to allow for respectively loading and unloading of a substrate 320 to and from the reflow chamber 302. The ambient zones provide a gas curtain that substantially seals the reflow chamber from the external atmosphere. The substrate 320, which can be loaded and unloaded from the reflow chamber 302, can comprise a part of a ball grid array package having a plurality of exposed conductive sites (not shown) to which portions of solder material 322 are applied.

The reflow system 300 also includes a plurality of heating zones 332, 334, 336, and 338 and a conveyor assembly 340 that is designed to move the substrate 320 through the plurality of heating zones 332, 334, 336, and 338 in the reflow chamber 302. The heating zones 332, 334, 336, and 338 include separate heaters 350, 352, 354, and 356 (e.g., radiant, convection, or conduction) that control the temperature of the respective heating zone 332, 334, 336, and 338 so that the temperature of the substrate 320 and solder material 322 can be adjusted as the substrate 320 moves through the reflow chamber 302. Although the reflow chamber 302 includes four individual heating zones 332, 334, 336, and 338, the reflow chamber 302 can include more (e.g., 5) or less (e.g., 1) heating zones.

The conveyor assembly 340 includes an input portion 360, an agitation portion 362, and an output portion 364. The input portion 360, the agitation portion 362, and the output portion 364 each comprise separate feed belts 370, 372, and 374 that can advance the substrate 320 respectively through at least part of the reflow chamber 302 and the heating zones 332, 334, 336, and 338. The feed belt 372 of the agitation portion 362 of conveyor assembly 340 is coupled to an ultrasonic generator 380. The ultrasonic generator can ultrasonically agitate during at least part of the reflow process the feed belt 372 of the agitation portion 362 of the conveyor assembly 340, which in turn can ultrasonically agitate the substrate 320 and solder material 322. By way of example, the ultrasonic generator can include an ultrasonic generating means 382, such as an oscillator with an oscillation source and a power supply. When the oscillator is driven, the ultrasonic generating means propagates an acoustical or vibrational wave with a frequency, which can be transmitted by feed belt 372 of the agitation portion 362 of the conveyor assembly 340 to the solder material 322.

During operation of the reflow system, the substrate 320 is positioned through the ambient zone 310 of the input end 304 of the reflow chamber 302 on the feed belt 370 of the input portion 360 of the conveyor assembly 340. The substrate 320 is advanced by the feed belt 370 of the conveyor assembly 340 through the heating zones 332 and 334 of the reflow chamber 302. While being advanced through the heating zones 332 and 334 of reflow chamber 302, the substrate 320 and solder material 322 are heated by the heaters 350 and 352 from about room temperature to the liquidus of solder material 322.

The substrate 320 is then advanced by the feed belt 370 of the input portion 360 to the feed belt 372 of the agitation portion 362 of the conveyor assembly 340. The feed belt 372 of the agitation portion 362 further advances the substrate 3020 through the heating zones 336 of the reflow chamber 302. While being advanced by the feed belt 372 of the agitation portion 362, the substrate 320 and solder material 322 are maintained at the liquidus of the solder material 322 by heater 354 of the heating zone 336 and subjected to ultrasonic agitation. The ultrasonic agitation is applied by the ultrasonic generator 380 that is coupled to the feed belt 372 of the agitation portion 362 of the conveyor assembly 340. The ultrasonic generator 380 ultrasonically vibrates the feed belt 372 of the agitation portion 362, which in turn ultrasonically vibrates the substrate 320 and the solder material 322, which is at liquidus. Ultrasonic agitation of the portions of solder material 322 can at least partially mitigate formation of voids, such as gas pockets or gas bubbles in the molten solder material 322.

The substrate 320 is advanced by the feed belt 372 of the agitation portion 362 to the feed belt 374 of the output portion 364. The feed belt 374 of the output portion 364 further advances the substrate 320 to output end 306 of the reflow chamber 302 where the substrate 320 and reflowed solder material 322 are allowed to cool to the solidus of the reflowed solder material 322. The cooled reflowed solder material 322 forms a plurality of solder bumps (not shown) that are metallurgically bonded to the conductive sites. The substrate 320 and solder bumps are subsequently removed from the reflow chamber 300 through the ambient zone 312 and allowed to cool to room temperature.

Those skilled in the art will also understand and appreciate that variations in the processing operations can be utilized in the formation of the solder bumps in accordance with an aspect of the present invention. For example, it is to be appreciated that instead of forming the solder bumps on contact pads, the solder bumps could be formed on the terminus of a conductive via, a portion of a conductive trace, or a portion of a metal interconnect. Moreover, it will be appreciated the solder flux can be applied using other solder flux dispensing methods. For example, these other methods can include other solder flux dipping methods as well as other solder flux transfer methods.

What has been described above includes examples and implementations of the present invention. Because it is not possible to describe every conceivable combination of components, circuitry or methodologies for purposes of describing the present invention, one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A method of forming a solder bump, the method comprising:
providing solder material on a conductive site of a substrate;
reflowing the solder material to provide a solder bump on the substrate; and
ultrasonically agitating the solder material during at least a part of the reflow.

2. The method of claim 1, the ultrasonic agitation at least partially mitigating the formation of voids in the solder bump.

3. The method of claim 1, the ultrasonic agitation being provided by an ultrasonic vibration that is transmitted to the solder material during reflow.

4. The method of claim 4, the ultrasonic vibration being provided via mechanical contact to the substrate.

5. The method of claim 4, the substrate being provided on a conveyor assembly during reflow, the conveyor assembly being ultrasonically vibrated to ultrasonically agitate the solder material.

6. The method of claim 1, the ultrasonic agitation being provided at a frequency of about 50 kHz to about 90 kHz.

7. The method of claim 1, the ultrasonic agitation being provided for about 50 seconds to about 150 seconds during the reflow.

8. The method of claim 1, the reflow including heating the solder material to temperature effective to melt the solder material, the melted solder material being ultrasonically agitated while at least partially melted.

9. The method of claim 1, the solder material comprising solder paste.

10. The method of claim 1, the solder material comprising preformed solder balls.

11. A method of forming solder bumps on a substrate, the method comprising:
providing a substrate having a plurality of conductive sites on a surface of the substrate;
providing solder material on each of the conductive sites;
reflowing the solder material to form a plurality of solder bumps, each solder including a surface being connected to one of the plurality of solder contacts; and
ultrasonically agitating the solder material during at least a part of the reflow, the ultrasonic agitation at least partially mitigating the formation of voids in the solder bumps.

12. The method of claim 11, the ultrasonic agitation being provided by an ultrasonic vibration that is transmitted to the solder material via mechanical contact to the substrate during reflow.

13. The method of claim 11, the substrate being provided on a conveyor assembly during reflow, the conveyor assembly being ultrasonically vibrated to ultrasonically agitate the solder material.

14. The method of claim 11, the ultrasonic agitation being provided at a frequency of about 50 kHz to about 90 kHz and for about 50 seconds to about 150 seconds during the reflow.

15. The method of claim 11, the solder material comprising solder paste.

16. The method of claim 1, the solder material comprising preformed solder balls.

17. A method of forming solder bumps on a substrate, the method comprising:
providing a substrate having a plurality of conductive sites on a surface of the substrate, the substrate comprising at least a portion of a ball grid array package;
providing solder material on each of the conductive sites;
reflowing the solder material to form a plurality of solder bumps, each solder including a surface being connected to one of the plurality of solder contacts; and
ultrasonically agitating the solder material during at least a part of the reflow, the ultrasonic agitation at least partially mitigating the formation of voids in the solder bumps.

18. The method of claim 17, the substrate being provided on a conveyor assembly during reflow, the conveyor assembly being ultrasonically vibrated to ultrasonically agitate the solder material.

19. The method of claim 17, the reflow including heating the solder material to temperature effective to melt the solder material, the melted solder material being ultrasonically agitated while at least partially melted.

20. The method of claim 117, the solder material comprising solder paste.

21. The method of claim 17, the solder material comprising preformed solder balls.
